(19) United States
(12) Patent Application Publication
(10) Pub. No.: US 2021/0142682 A1
(43) Pub. Date: May 13, 2021

(54) SYSTEMS AND METHODS FOR PROVIDING AN AIRCRAFT APPROVAL SERVICES PLATFORM

(71) Applicant: GE Aviation Systems LLC, Grand Rapids, MI (US)

(72) Inventors: Kenneth Stewart, Somerville, MA (US); Wendy Ljungren, Grand Rapids, MI (US); Vineet Mehta, Grand Rapids, MI (US); Courtney Albers, Grand Rapids, MI (US)

(21) Appl. No.: 17/090,290

(22) Filed: Nov. 5, 2020

Related U.S. Application Data
(60) Provisional application No. 62/931,579, filed on Nov. 6, 2019.

(51) Int. Cl. G08G 5/00; G06Q 10/10; G06Q 30/00

(52) U.S. Cl. CPC G08G 5/0039; G06Q 30/018; G06Q 30/016; G06Q 10/103

(57) ABSTRACT

Systems and methods for providing an aviation approval services platform. One embodiment of a method includes receiving customer data. The customer data may include data related to an operator, data related to a vehicle, and/or data related to an intended operation of the vehicle by the operator. The method may include determining compliance requirements of a regulatory authority for approving an approval application for the operator and/or the vehicle for the intended operation, determining whether the customer data is sufficient to meet the compliance requirements of the regulatory authority for the intended operation, and in response to determining that the customer data is not sufficient to meet the compliance requirements, providing a recommendation for meeting the compliance requirements. In some embodiments, in response to determining that the customer data is sufficient to meet the compliance requirements, submitting an application to the regulatory authority on behalf of the operator.

### CROSS REFERENCE

This application claims the benefit of U.S. Provisional Application Ser. No. 62/931,579, filed on Nov. 6, 2019, which is hereby incorporated by reference in its entirety.

### TECHNICAL FIELD

The disclosure relates generally to aircraft services, and, more particularly, to an apparatus, system, and method of providing an aviation approval services platform.

### BACKGROUND

Currently, the waiver application (or approval application) process for many aerial vehicles, including small unmanned aerial systems (sUAS) is a difficult and confusing process. Many of the approval applications are hundreds of pages long and the regulatory authority who examines applications typically provides no guidance before, during, or after the application is submitted. As such, it may be extremely frustrating and time consuming to acquire the desired approvals and authorizations. Similarly, for many vehicle manufacturers, the process is just as difficult, thus delaying bringing the products to market. Thus, a need exists in the industry for an aviation approval services platform.

### SUMMARY

Systems and methods for providing an aviation approval services platform. One embodiment of a method includes receiving customer data. The customer data may include data related to an operator, data related to a vehicle, and/or data related to an intended operation of the vehicle by the operator. The method may include determining compliance requirements of a regulatory authority for approving an approval application for the operator and/or the vehicle for the intended operation, determining whether the customer data is sufficient to meet the compliance requirements of the regulatory authority for the intended operation, and in response to determining that the customer data is not sufficient to meet the compliance requirements, providing a recommendation for meeting the compliance requirements. In some embodiments, in response to determining that the customer data is sufficient to meet the compliance requirements, submitting an application to the regulatory authority on behalf of the operator.

In another embodiment, a system includes a remote computing device that includes a processor and a memory component that stores logic that, when executed by the processor, causes the system to receive customer data, where the customer data includes data related to an operator, data related to a vehicle, and/or data related to an intended operation of the vehicle by the operator. The logic may further cause the system to determine compliance requirements of a regulatory authority implemented by a third party computing device for approving an approval application for the operator and/or the vehicle for the intended operation, determine whether the customer data is sufficient to meet the compliance requirements of the regulatory authority for the intended operation, and in response to determining that the customer data is not sufficient to meet the compliance requirements, provide a recommendation for meeting the compliance requirements. In some embodiments, the logic causes the system to, in response to determining that the customer data is sufficient to meet the compliance requirements, submit an application to the third party computing device on behalf of the operator.

Another embodiment includes a non-transitory computer-readable medium that stores logic that, when executed by a computing device, causes the computing device to receive customer data, where the customer data includes data related to an operator, data related to a vehicle, and data related to an intended operation of the vehicle by the operator. The logic may further cause the computing device to determine compliance requirements of a regulatory authority for approving an approval application for the vehicle for the intended operation, determine whether the customer data is sufficient to meet the compliance requirements of the regulatory authority for the intended operation, and in response to determining that the customer data is not sufficient to meet the compliance requirements, provide a recommendation for meeting the compliance requirements. In some embodiments, the logic further causes the computing device to, in response to determining that the customer data is sufficient to meet the compliance requirements, submit an application to the regulatory authority on behalf of the operator.

These and additional features provided by the embodiments of the present disclosure will be more fully understood in view of the following detailed description, in conjunction with the drawings.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1A depicts a computing environment for providing an aviation approval services platform, according to embodiments described herein;

FIG. 1B depicts an architecture for providing an aviation approval services platform, according to embodiments described herein;

FIG. 2 depicts a flow diagram illustrating data and rules that may be applied to a given request for regulatory vehicle approval, as described herein;

FIG. 3 depicts a flowchart for providing an aviation approval services platform, according to embodiments described herein; and

FIG. 4 depicts a remote computing device for providing an aviation approval services platform, according to embodiments provided herein.

### DETAILED DESCRIPTION

Embodiments disclosed herein include systems, methods, and non-transitory computer-readable mediums for providing an aviation approval services platform. Some embodiments are directed to aircraft and aircraft equipment manufacturers, who may perform physical testing and qualification of aircrafts and aircraft equipment; and approvals related to those who service the flying of aircraft, such as those related to the application of federal aviation administration (FAA) and similar approval processes. More particularly, the embodiments may relate to preapproval and pre-flight certification of aircrafts, equipment, and flight services such as flight plans (where approvals may include application of information from various resources as to whether an aircraft is capable of performing the proposed operation, and whether the operation is acceptable for performance). Some embodiments are directed to the authorization of in-flight activities, such as checking for compliance as to operators, aircraft capabilities, and flight plans with the preapproved and/or certified initial application, and/or the assessment of necessary modifications to approve flight services.

For certain requests, insurance aspects may be reviewed. For some requests, radio frequency signatures may occur, such as in relation to nearby FCC approved cell phone towers. This may ensure the compliance of equipment associated with a given aircraft is assessed within a requested flight plan area having cell phone communication towers. This may be compared with acceptable and unacceptable geographies over which flight can occur, such as inaccessibility of flights within a certain number of miles of an airport, over a stadium, between tall buildings, or the like.

Accordingly, some embodiments may follow a dynamic approval checklist that is unique to each request, and that is relationally applied. The relationally applied information may include rules, data, static information, dynamic information, or the like. As an example, for a vehicle such as an unmanned aircraft, the dynamic approval checklist may include verification of registration data; a capabilities authorization of equipment, such as the unmanned aircraft model and equipment; a location authorization comprising the vehicle's flight plan; authorization of local geography and similar information; a pilot and/or operator approval, which may include operator registration, flight hours, or currency of training; any approved authorizations, waivers or exemptions; current operating conditions, such as the weather and the time of day; current no fly zones, date, time of day, or other flight restrictions, etc.

Further, the dynamic approval checklist may include a weighting and balancing of the various relationally applied factors, where the weighting and balancing may vary in accordance with machine learning over time. For example, applied aspects from a checklist may be applied based on priority, where certain factors are weighted more heavily than other factors in a given approval request. In some embodiments, static factors, which may be more simply approved, may be prioritized in order to expedite processing and improve allocation of computing resources.

As another example, a flight plan proximate to a large stadium or other limited fly geography, may generally require dynamic application of rules regarding over-stadium flight operations. However, if the requested operation is to occur at 4:30 AM, embodiments determine that the over-stadium flight aspect has a lower dynamic or no priority in the decision process, at least because the system may learn that there is never a game at a stadium at 4:30 AM. Accordingly, embodiments may be dynamically optimized because the embodiments may learn that, at certain times of day, in certain geographies, in certain weather conditions, etc., one or more of the relationally applied rules or factors need not be applied to, or should be deprioritized within, a given flight request. Thus, in accordance with the embodiments, a plurality of cross validations may occur.

That is, the embodiments may relationally employ many different sources of information, which may be cross-validated against one another and against a flight request. Such cross validations may be unique to each flight request, may be modified based on machine learning over time, and/or may be performed to optimize dedication of computing resources.

As another example, the FAA's approval criteria are historically static, and may include allowances by operator and aircraft type. The embodiments may apply the FAA's typical static checks, but may additionally measure and adjust these FAA checks in real time, such as based on traffic density, available altitudes, current weather conditions, and the like. Further, other static factors may vary by location. For example, certain geographic locations may allow flight over streets only. Such community preferences by micro region may be assessed based on cross validation of the location of the request and flight plan to a community's zoning rules in any region in which the flight plan is requested.

Some embodiments may perform other cross validations not available in the known art. For example, the density of manned, unmanned, or other flights at certain times of the day and year may be validated in real time, checked against an approval request in real time, and may be historically tracked such that machine learning may further refine such checks. By way of example with respect to the example referenced above, although stadiums may be no fly zones during active games, the disclosed system may readily allow for checking with local sports team sites in any given geography to enable the disallowing of overflights during not only professional sporting events, but additionally during college or high school events, or concerts, in a micro region. Further, machine learning may enable the system to adjust whether the need exists to apply a rule, such as the aforementioned stadium no fly rule.

These embodiments may also make at least one physical check for an approval request. For example, the system may maintain an update from third-party data of the limitations of any aircraft, as well as variations in the geography (e.g., population densities, schools, airspace, terrain, obstacles, cell coverage, etc.), topology, or structures in a given area. For example, the disclosed systems may readily check the physical presence or absence of new buildings or demolished buildings in a given micro region.

As another example, infrastructure in a given micro region, such as radio, television, and cell service, may be adversely affected by the operation of particular aircraft in the region, and vice versa. Accordingly, such operation of aircraft may be limited at all times, or only during heightened times of use for those radio, television, and/or cellular service signals.

In sum, the embodiments provide an apparatus, system and method for receiving and checking aircraft certification and/or aircraft flight requests. These embodiments may allow for cross validation of such requests against a variety of third-party data sources. The embodiments may further improve computing resource allocation to expediently address flight requests, flight conflicts, and the like, and hence may improve public infrastructure operation. The embodiments may further include machine learning aspects that allow for automated modifications to application of rules and third-party data for cross validation related to flight approval requests. Such machine learning may allow for dynamic improvements in computing resource allocations, which may further improve flight approval efficiencies, public safety, and infrastructure operation. The systems and methods for providing an aircraft approval service platform incorporating the same will be described in more detail, below.

Referring now to the drawings, FIG. 1A depicts a computing environment for providing an aviation approval services platform, according to embodiments described herein. As illustrated, the computing environment may include a network 100, such as the internet, public switched telephone network, mobile telephone network, mobile data network, local network (wired or wireless), peer-to-peer connection, and/or other network for providing the functionality described herein.

Coupled to the network 100 are a user computing device 102a, a vehicle 102b, a remote computing device 104, and a third party computing device 106. The user computing device 102a may be configured as any device capable of communicating with the vehicle 102b and/or the remote computing device 104. In some embodiments, the user computing device 102a may be portable to provide at least some line of sight control over the vehicle 102b. For some embodiments, the user computing device 102a represents one or more devices for controlling the vehicle 102b and communicating with the remote computing device 104, as described herein.

The vehicle 102b may be configured as any aerial vehicle, such as an unmanned aerial system (UAS), a small UAS (sUAS), an airplane, helicopter, drone, etc. The vehicle 102b may each be configured with one or more sensors, such as a temperature sensor, an altitude sensor, a data sensor, an antenna, a transceiver, a radar altimeter, a depth sensor, a camera, a microphone, an accelerometer, etc. that can detect altitude, position, pressure, temperature, satellite data, communications from the remote computing device 104 and/or the third party computing device 106, and/or perform other actions.

Also coupled to network 100 is the remote computing device 104. The remote computing device 104 represents one or more different devices for providing the functionality described herein and as such, may be configured as a server, personal computers, databases, and/or other computing device. Specific examples include a UAS traffic management (UTM) system, an unmanned service system (USS), a ground control station, a mapping system, a third-party computing device, a system for providing conformance volume based airspace access, and/or other computing device or system. The remote computing device 104 may include a memory component 140, which may store air mobility platform (AMP) logic 144. The AMP logic 144 may include waivers logic 144a, traffic management logic 144b, clearing logic 144c, and interworking logic 144d. The AMP logic 144 may be configured to cause the remote computing device 104 to provide a platform for the user computing device 102a to apply to a regulatory body (such as the FAA) or other third party for acceptance and/or a waiver to fly the vehicle 102b. As described in more detail below, the platform may provide a workflow for the user to navigate to input vehicle 102b information, as well as provide feedback on necessary modifications to the application prior to the application and/or waiver being submitted to the regulatory body.

Additionally, the AMP logic 144 may be configured to cause the remote computing device 104 to monitor operation of the vehicle 102b, such as via the traffic management logic 144b and/or the clearing logic 144c. Specifically, when the vehicle 102b is in operation, the user computing device 102a may submit a flight plan to the remote computing device 104. In flight, the user computing device 102a may receive information regarding compliance of the vehicle 102b to the flight plan. In response to determining that the vehicle 102b did not comply with the flight plan, the remote computing device 104 may report the user and/or the vehicle 102b or otherwise prevent the user and/or vehicle 102b from flying.

Also coupled to the network 100 is the third party computing device 106. The third party computing device 106 may represent one or more computing device that is operated by one or more third parties to provide authorization to the vehicle 102b and/or other vehicles (such as the FAA or other regulatory body). As will be understood, the third party computing device 106 may include hardware and/or software, similar to that described in reference to the remote computing device 104. In some embodiments, the third party computing device 106 may represent a plurality of different entities and/or computing devices for providing the functionality described herein. While labeled as third party computing device 106, it will be understood that this representation may be operated by any third party (or a plurality of individual third parties) to provide the requested data, as described herein.

FIG. 1B depicts an architecture for providing an aviation approval services platform, according to embodiments described herein. The architecture of FIG. 1B may include a plurality of autonomous services, engines and/or platforms that are communicative with third-party data sources, where the third-party data sources may be rules-based, non-rules based, informationally based, or the like. As illustrated, the users 120 of the platform may include an aircraft manufacturer 122, a regulatory waiver/exception requestor 124, an advisor, and/or other user. The applications 126 that the platform utilizes may include an approval services application 128, an advisory application 130, an air mobility mobile application 132, a web portal 134, an operations center 136, and a ground control application 138. The aircraft manufacturer 122 and the regulatory waiver/exception requestor 124 may utilize the approval services application 128. Similarly, ground control application 138 may communicate with the vehicle 102b.

The AMP logic 144 may also be provided, which includes the waivers logic 144a, the traffic management logic 144b, the clearing logic 144c, and the interworking logic 144d. The waivers logic 144a may include a UAS approval service 154, kit configuration data 156, an operational approval service module 158, approved UAS models data 160, and an operational authorization module 162. The AMP logic 144 may additionally include and/or communicate with a discovery and synchronization service 166 and/or one or more UAS service suppliers (USSs) 168. Also provided is a USS interworking infrastructure 164 that facilitates communication between the USSs 168 and a discovery and synchronization service 166.

Additionally, the AMP logic 144 may communicate with one or more third party data sources 170, which may be represented by the remote computing device 104 in FIG. 1A. The third party data sources 170 may include public data 172, such as FAA data, state data, and/or other public data. The third party data sources 170 may include supplemental data 174, such as weather, geography, obstacle, and surveillance.

As an example, some embodiments may provide a multilayer autonomous approval service for aircraft, equipment, and/or operational approvals, which may be provided for manned and/or unmanned aircraft systems. Such approvals may draw on the third party data sources 170 (at least a portion of which may be represented as remote computing device 104 from FIG. 1A), including data models provided by authoritative bodies, such as the FAA, in relation to aircraft registration, operator registrations, relevant identity certifications of both aircraft and operators, flight plan submissions, capabilities verification, testing data, and so on. Additionally, some embodiments may draw on other third party data sources that are beyond typical approval rules, including but not limited to authoritative data provided by other rulemaking bodies, such as the FCC in relation to radiofrequency operation within FCC bandwidth guidelines, by way of nonlimiting example.

In operation, the embodiments of FIG. 1A, 1B may execute before and/or during flight, such as to plan, approve and modify airspace and submitted flight plans, monitor conformance with flight plans, monitor for confliction of flight plans, resolve conflicts in flight plans, manage airspace (such as may include exclusionary management for first responders/no fly zones as they arise, and the like), and so on. These autonomous preflight and inflight monitoring may be communicated to the approval services and/or the approval services user interface.

The AMP logic 144 may interact with any of a plurality of third-party data sources, such as but not limited to at least one of the following: a regulatory third party, a governmental third party, a historical third party, and/or a weather-related third party. For example, aircraft and ground-based surveillance may be monitored and data obtained therefrom; obstacle detection sites may be accessed, such as may include terrain, geographical and structural assessment. Weather forecasting may be accessed for any area relevant to the request; aircraft use, capability, health, and performance data and history may be assessed; and current airspace activity by other aircraft, no fly zones, and the like may also be monitored.

The computing environment provided in FIG. 1B may also include sockets to one or more remote data sources, and may select relevant data that is unique to each approval request for use by the AMP logic 144. Thereby, real-time autonomous approval services may be provided in the embodiments, even in the event of submission of a large number of approval requests in a variety of different geographies and air spaces substantially simultaneously, and/or where each necessitates assessment and manipulation of data unique to each such geography, airspace, operator, based on access by sockets from the AMP logic 144 described herein to those unique third party data resources for each case of requested approval. The approval services referenced herein may include registration, which may include certification of manned and/or unmanned aircraft for airworthiness, operation history, operator identifications, and the like. Also included is authorization for specific operations, locations, operators, etc., as well as pursuit of regulation compliance, waivers or exemptions for the aforementioned authorizations. Further included are authentications, which may persist not only during preflight but inflight for an approved flight application.

As another nonlimiting example, an application to the user interface may result in a vehicle certification. The vehicle 102b may be approved as capable of engaging in the requested activity. Such approvals may be sought by, for example, aircraft manufacturers, pilots, users, and/or others. Also included in the requisite approvals returned to the user interface may be approvals of flight requests. Such approvals may include, for example, operator approvals and certifications, flight plan approvals, certifications, or modifications, etc. Thereafter, the disclosed systems, modules, platforms, and engines may confirm compliance, such as for an aircraft service provider, once a flight plan and operator are approved and the vehicle 102b is in flight.

As another example, the higher risk the operation requested for approval is, the more analysis that may occur in the disclosed system in order to authorize the request. That is, a rigor versus risk analysis may be performed where the disclosed engine engages in greater rigor of analysis, such as may include drawing on additional third party information and/or engaging in more algorithmic applications, if the risk of the requested activity is deemed heightened.

Such risk may include a number of people that could be injured, in danger, or inconvenienced by certain activity. That is, if no persons stand a likelihood of injury by granting an approval, minimal analysis of the approval request may occur. At the other end of the spectrum, if a significant number of people may be exposed to harm or inconvenience by a request, Department of Defense-level security analysis may occur, detailed analyses of local government, operator and aircraft manufacturer insurance may occur, environmental analysis may be performed, and high-level safety and security analysis, checks, and monitoring may occur.

FIG. 2 depicts a flow diagram illustrating data and rules that may be applied to a given request for regulatory vehicle approval, as described herein. As illustrated in section 230 a user may bring a concept of operations, including customer data 232 to the platform. The user may input this customer data 232 via a web interface and/or via other mechanisms. At section 240, the platform or administrator will receive the customer data 232, along with standards and rules data 234, best practices data 236, and feedback from previous applications (collectively referred to as knowledge base 238). The knowledge base 238 may also be utilized for improving results in a future application. In section 242, the platform may apply the customer data 232 to determine the validation criteria. Validation criteria may include those requirements for the user to be approved for performing the actions being requested. In section 244, the platform may recommend upgrades and/or user training to comply with the regulatory requirements. In section 246, the waiver or other approval application may be submitted and in section 248, the regulatory body may provide authorization. The information from sections 244, 246 may additionally communicated back to the knowledge base 238 for future approval applications.

FIG. 3 depicts a flowchart for providing an aviation approval services platform, according to embodiments described herein. As illustrated at block 340, customer data 232 may be received. The customer data 232 may include data related to an operator, data related to a vehicle 102b, and/or data related to an intended operation of the vehicle 102b by the operator. At block 342, compliance requirements of a regulatory authority may be determined for approving the operator and/or the vehicle 102b for the intended operation. In some embodiments, determining the compliance requirements includes determining compliance requirements of a plurality of third parties, such as a regulatory third party, a governmental third party, a historical third party, and/or a weather-related third party. At block 344, a determination may be made regarding whether the customer data 232 is sufficient to meet the compliance requirements of the regulatory authority for the intended operation. This determination may include determining at least one error in the application, such as missing information, insufficient credentials, insufficient vehicle components, etc. If not, at block 346 a recommendation may be provided for meeting the compliance requirements. If the customer data 232 is sufficient at block 344, the process proceeds to block 348, where the approval application may be submitted to the regulatory authority on behalf of the operator.

It should be understood that once a vehicle 102b and/or user has been granted approval pursuant to the process of FIG. 3, embodiments may monitor the user and/or monitor usage of the vehicle 102b. These embodiments may determine that usage of the vehicle 102b does not comply with compliance requirements and revoke a privilege of the vehicle 102b and/or the operator.

It should be also understood that some embodiments may be configured to receive a similar error rejection of the application from the regulatory authority. In response to receiving the rejection, a determination may be made regarding at least one error in the application and data related to the at least one error may be utilized for preventing a similar error in a future application.

FIG. 4 depicts a remote computing device 104 that may be utilized for providing an approval services platform, according to embodiments provided herein. As illustrated, the remote computing device 104 includes a processor 430, input/output hardware 432, network interface hardware 434, a data storage component 436, which stores application data 438a, compliance data 438b, and/or other data, and the memory component 140. The application data 438a may include the kit configuration data 146, approved aircraft models data 160 and/or other data from FIG. 1B, as well as customer data 232, the standards and rules data 234, the best practices data 236, the past results and/or other data as provided in FIG. 2. The compliance data 438b may include similar data that may be utilized to monitor compliance of a vehicle 102b when in use. The memory component 140 may be configured as volatile and/or nonvolatile memory and as such, may include random access memory (including SRAM, DRAM, and/or other types of RAM), flash memory, secure digital (SD) memory, registers, compact discs (CD), digital versatile discs (DVD), and/or other types of non-transitory computer-readable mediums. Depending on the particular embodiment, these non-transitory computer-readable mediums may reside within the remote computing device 104 and/or external to the remote computing device 104.

The memory component 140 may store operating system logic 442 and the AMP logic 144, which may include the waivers logic 144a, the traffic management logic 144b, the clearing logic 144c, and the interworking logic 144d. As illustrated, the AMP logic 144 may include a plurality of different pieces of logic, each of which may be embodied as a computer program or module, firmware, and/or hardware, as an example. A local interface 446 is also included in FIG. 4 and may be implemented as a bus or other communication interface to facilitate communication among the components of the remote computing device 104.

The processor 430 may include any processing component operable to receive and execute instructions (such as from a data storage component 436 and/or the memory component 140). As described above, the input/output hardware 432 may include and/or be configured to interface with the components of FIG. 4.

The network interface hardware 434 may include and/or be configured for communicating with any wired or wireless networking hardware, including an antenna, a modem, a LAN port, wireless fidelity (Wi-Fi) card, WiMAX card, mobile communications hardware, and/or other hardware for communicating with other networks and/or devices. From this connection, communication may be facilitated between the remote computing device 104 and other computing devices, such as those depicted in FIG. 1.

The operating system logic 442 may include an operating system and/or other software for managing components of the remote computing device 104. As discussed above, the AMP logic 144 may reside in the memory component 140 and may be configured to cause the processor 430 to provide a platform for a user and/or administrator to submit an approval application, as described above. Similarly, the AMP logic 144 may be utilized to monitor operation of the vehicle 102b to ensure compliance with the regulations for which the user and/or vehicle 102b were approved, and/or provide other similar functionality.

It should be understood that while the components in FIG. 4 are illustrated as residing within the remote computing device 104, this is merely an example. In some embodiments, one or more of the components may reside external to the remote computing device 104. It should also be understood that, while the remote computing device 104 is illustrated as a single device, this is also merely an example. In some embodiments, the waivers logic 144a, the traffic management logic 144b, the clearing logic 144c, and/or the interworking logic 144d may reside on different computing devices. As another example, one or more of the functionalities and/or components described herein may be provided by a remote computing device 104, the user computing device 102a, the third party computing device 106, and/or other devices, which may be coupled to the remote computing device 104 via a network connection (wired or wireless). These devices may also include hardware and/or software for performing the functionality described herein.

Additionally, while the remote computing device 104 is illustrated with the waivers logic 144a, the traffic management logic 144b, the clearing logic 144c, and the interworking logic 144d as separate logical components, this is also an example. In some embodiments, a single piece of logic (or multiple pieces of logic) may cause the desired computing device to provide the described functionality.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

Further aspects of the invention are provided by the subject matter of the following clauses:

A method for providing an aviation approval services platform comprising: receiving, by a computing device, customer data, wherein the customer data includes data related to an operator, data related to a vehicle, and data related to an intended operation of the vehicle by the operator; determining, by the computing device, compliance requirements of a regulatory authority for approving an approval application for at least one of the following: the operator or the vehicle for the intended operation; determining, by the computing device, whether the customer data is sufficient to meet the compliance requirements of the regulatory authority for the intended operation; in response to determining that the customer data is not sufficient to meet the compliance requirements, providing, by the computing device, a recommendation for meeting the compliance requirements; and in response to determining that the customer data is sufficient to meet the compliance requirements, submitting, by the computing device, an application to the regulatory authority on behalf of the operator.

The method for any proceeding clause, further comprising: monitoring usage of the vehicle; determining that usage of the vehicle does not comply with the compliance requirements; and revoking a privilege of at least one of the following: the vehicle or the operator.

The method for any proceeding clause, wherein determining the compliance requirements includes determining at least one of the following: verification of registration data of the vehicle, a capabilities authorization of the vehicle, a capabilities authorization of equipment of the vehicle, a location authorization of a flight plan for the vehicle, an authorization of local geography along the flight plan, an operator approval, current operating conditions, date, time of day, or flight restrictions.

The method of any preceding clause, further comprising receiving a rejection of the application from the regulatory authority; determining at least one error in the application; and utilizing data related to the at least one error for preventing a similar error in a future application.

The method of any preceding clause, wherein the customer data further includes machined learned knowledge, standards and rules data, and best practices data.

The method of any preceding clause, further comprising making a physical check for an approval request.

The method of any preceding clause, wherein determining compliance requirements of the regulatory authority further includes determining compliance requirements of a plurality of third parties and wherein the plurality of third parties include at least one of the following: a regulatory third party, a governmental third party, a historical third party, or a weather-related third party.

A system for providing an aviation approval services platform comprising: a remote computing device that includes a processor and a memory component that stores logic that, when executed by the processor, causes the system to perform at least the following: receive customer data, wherein the customer data includes data related to at least one of the following: an operator, data related to a vehicle, or data related to an intended operation of the vehicle by the operator; determine compliance requirements of a regulatory authority implemented by a third party computing device for approving an approval application for at least one of the following: the operator or the vehicle for the intended operation; determine whether the customer data is sufficient to meet the compliance requirements of the regulatory authority for the intended operation; in response to determining that the customer data is not sufficient to meet the compliance requirements, provide a recommendation for meeting the compliance requirements; and in response to determining that the customer data is sufficient to meet the compliance requirements, submit an application to the third party computing device on behalf of the operator.

The system of any preceding clause, wherein the logic further causes the system to perform at least the following: monitor usage of the vehicle; determine that usage of the vehicle does not comply with the compliance requirements; and revoke a privilege of at least one of the following: the vehicle or the operator.

The system of any preceding clause, wherein determining the compliance requirements includes determining at least one of the following: verification of registration data of the vehicle, a capabilities authorization of the vehicle, a capabilities authorization of equipment of the vehicle, a location authorization of a flight plan for the vehicle, an authorization of local geography along the flight plan, an operator approval, current operating conditions, date, time of day, or flight restrictions.

The system of nay preceding clause, wherein the logic further causes the system to perform at least the following: receive a rejection of the application from the regulatory authority; determine at least one error in the application; and utilize data related to the at least one error for preventing a similar error in a future application.

The system of any preceding clause, further comprising making a physical check for an approval request.

The system of any preceding clause, wherein determining compliance requirements of the regulatory authority further includes determining compliance requirements of a plurality of third parties and wherein the plurality of third parties include at least one of the following: a regulatory third party, a governmental third party, a historical third party, or a weather-related third party.

The system of any preceding clause, further comprising the third party computing device that facilitates approval of the application.

A non-transitory computer-readable medium that stores logic that, when executed by a computing device, causes the computing device to perform at least the following: receive customer data, wherein the customer data includes data related to an operator, data related to a vehicle, and data related to an intended operation of the vehicle by the operator; determine compliance requirements of a regulatory authority for approving an approval application for the vehicle for the intended operation; determine whether the customer data is sufficient to meet the compliance requirements of the regulatory authority for the intended operation; in response to determining that the customer data is not sufficient to meet the compliance requirements, provide a recommendation for meeting the compliance requirements; and in response to determining that the customer data is sufficient to meet the compliance requirements, submit an application to the regulatory authority on behalf of the operator.

The non-transitory computer-readable medium of any preceding clause, wherein the logic further causes the computing device to perform at least the following: monitor usage of the vehicle; determine that usage of the vehicle does not comply with the compliance requirements; and revoke a privilege of at least one of the following: the vehicle or the operator.

The non-transitory computer-readable medium of any preceding clause, wherein determining the compliance requirements includes determining at least one of the following: verification of registration data of the vehicle, a capabilities authorization of the vehicle, a capabilities authorization of equipment of the vehicle, a location authorization of a flight plan for the vehicle, an authorization of local geography along the flight plan, an operator approval, current operating conditions, date, time of day, or flight restrictions.

The non-transitory computer-readable medium of any preceding clause, wherein the logic further causes the computing device to perform at least the following: receive a rejection of the application from the regulatory authority; determine at least one error in the application; and utilize data related to the at least one error for preventing a similar error in a future application.

The non-transitory computer-readable medium of any preceding clause, wherein the customer data further includes machined learned knowledge, standards and rules data, and best practices data.

The non-transitory computer-readable medium of any preceding clause, wherein determining compliance requirements of the regulatory authority further includes determining compliance requirements of a plurality of third parties and wherein the plurality of third parties include at least one of the following: a regulatory third party, a governmental third party, a historical third party, or a weather-related third party.

What is claimed is:

1. A method for providing an aviation approval services platform comprising:
receiving, by a computing device, customer data, wherein the customer data includes data related to an operator, data related to a vehicle, and data related to an intended operation of the vehicle by the operator;
determining, by the computing device, compliance requirements of a regulatory authority for approving an approval application for at least one of the following: the operator or the vehicle for the intended operation;
determining, by the computing device, whether the customer data is sufficient to meet the compliance requirements of the regulatory authority for the intended operation;
in response to determining that the customer data is not sufficient to meet the compliance requirements, providing, by the computing device, a recommendation for meeting the compliance requirements; and
in response to determining that the customer data is sufficient to meet the compliance requirements, submitting, by the computing device, an application to the regulatory authority on behalf of the operator.

2. The method of claim 1, further comprising:
monitoring usage of the vehicle;
determining that usage of the vehicle does not comply with the compliance requirements; and
revoking a privilege of at least one of the following: the vehicle or the operator.

3. The method of claim 1, wherein determining the compliance requirements includes determining at least one of the following: verification of registration data of the vehicle, a capabilities authorization of the vehicle, a capabilities authorization of equipment of the vehicle, a location authorization of a flight plan for the vehicle, an authorization of local geography along the flight plan, an operator approval, current operating conditions, date, time of day, or flight restrictions.

4. The method of claim 1, further comprising:
receiving a rejection of the application from the regulatory authority;
determining at least one error in the application; and
utilizing data related to the at least one error for preventing a similar error in a future application.

5. The method of claim 1, wherein the customer data further includes machined learned knowledge, standards and rules data, and best practices data.

6. The method of claim 1, further comprising making a physical check for an approval request.

7. The method of claim 1, wherein determining compliance requirements of the regulatory authority further includes determining compliance requirements of a plurality of third parties and wherein the plurality of third parties include at least one of the following: a regulatory third party, a governmental third party, a historical third party, or a weather-related third party.

8. A system for providing an aviation approval services platform comprising:
a remote computing device that includes a processor and a memory component that stores logic that, when executed by the processor, causes the system to perform at least the following:
receive customer data, wherein the customer data includes data related to at least one of the following: an operator, data related to a vehicle, or data related to an intended operation of the vehicle by the operator;
determine compliance requirements of a regulatory authority implemented by a third party computing device for approving an approval application for at least one of the following: the operator or the vehicle for the intended operation;
determine whether the customer data is sufficient to meet the compliance requirements of the regulatory authority for the intended operation;
in response to determining that the customer data is not sufficient to meet the compliance requirements, provide a recommendation for meeting the compliance requirements; and
in response to determining that the customer data is sufficient to meet the compliance requirements, submit an application to the third party computing device on behalf of the operator.

9. The system of claim 8, wherein the logic further causes the system to perform at least the following:
monitor usage of the vehicle;
determine that usage of the vehicle does not comply with the compliance requirements; and
revoke a privilege of at least one of the following: the vehicle or the operator.

10. The system of claim 9, wherein determining the compliance requirements includes determining at least one of the following: verification of registration data of the vehicle, a capabilities authorization of the vehicle, a capabilities authorization of equipment of the vehicle, a location authorization of a flight plan for the vehicle, an authorization of local geography along the flight plan, an operator approval, current operating conditions, date, time of day, or flight restrictions.

11. The system of claim 8, wherein the logic further causes the system to perform at least the following:
receive a rejection of the application from the regulatory authority;
determine at least one error in the application; and
utilize data related to the at least one error for preventing a similar error in a future application.

12. The system of claim 8, further comprising making a physical check for an approval request.

13. The system of claim 8, wherein determining compliance requirements of the regulatory authority further includes determining compliance requirements of a plurality of third parties and wherein the plurality of third parties include at least one of the following: a regulatory third party, a governmental third party, a historical third party, or a weather-related third party.

14. The system of claim 8, further comprising the third party computing device that facilitates approval of the application.

15. A non-transitory computer-readable medium that stores logic that, when executed by a computing device, causes the computing device to perform at least the following:
receive customer data, wherein the customer data includes data related to an operator, data related to a vehicle, and data related to an intended operation of the vehicle by the operator;
determine compliance requirements of a regulatory authority for approving an approval application for the vehicle for the intended operation;
determine whether the customer data is sufficient to meet the compliance requirements of the regulatory authority for the intended operation;
in response to determining that the customer data is not sufficient to meet the compliance requirements, provide a recommendation for meeting the compliance requirements; and
in response to determining that the customer data is sufficient to meet the compliance requirements, submit an application to the regulatory authority on behalf of the operator.

16. The non-transitory computer-readable medium of claim 15, wherein the logic further causes the computing device to perform at least the following:
monitor usage of the vehicle;
determine that usage of the vehicle does not comply with the compliance requirements; and
revoke a privilege of at least one of the following: the vehicle or the operator.

17. The non-transitory computer-readable medium of claim 15, wherein determining the compliance requirements includes determining at least one of the following: verification of registration data of the vehicle, a capabilities authorization of the vehicle, a capabilities authorization of equipment of the vehicle, a location authorization of a flight plan for the vehicle, an authorization of local geography along the flight plan, an operator approval, current operating conditions, date, time of day, or flight restrictions.

18. The non-transitory computer-readable medium of claim 15, wherein the logic further causes the computing device to perform at least the following:
receive a rejection of the application from the regulatory authority;
determine at least one error in the application; and
utilize data related to the at least one error for preventing a similar error in a future application.

19. The non-transitory computer-readable medium of claim 15, wherein the customer data further includes machined learned knowledge, standards and rules data, and best practices data.

20. The non-transitory computer-readable medium of claim 15, wherein determining compliance requirements of the regulatory authority further includes determining compliance requirements of a plurality of third parties and wherein the plurality of third parties include at least one of the following: a regulatory third party, a governmental third party, a historical third party, or a weather-related third party.
